(19) United States
(12) Patent Application Publication
(10) Pub. No.: US 2003/0070357 A1
(43) Pub. Date: Apr. 17, 2003

(54) Floatable planting apparatus

(76) Inventor: Shih Ming Huang, Taichung (TW)

Correspondence Address: Shih Ming Huang, P.O. Box 63-99, Taichung, 406, TW

(21) Appl. No.: 09/976,087

(22) Filed: Oct. 15, 2001

(51) Int. Cl. A01G 9/02

(52) U.S. Cl. 47/66.3

(57) ABSTRACT

A floatable planting device includes two or more floatable bases coupled together with one or more couplers for floating or buoyant on the pool and for supporting and growing the plants naturally without watering and without providing nutrition to the plants. The bases may be used for shading the pools and for cleaning the water and for airing the pools and for improving the aquatic animals breeding environment to a comfortable environment. The couplers may rotatably or flexibly couple the bases together for allowing the bases to be rotated or moved relative to each other.

### BACKGROUND OF THE INVENTION

1. Field of the Invention

The present invention relates to a planting apparatus, and more particularly to a floatable planting apparatus.

2. Description of the Prior Art

U.S. Pat. No. 4,916,857 to Kinghorn discloses one of the typical planting devices and comprises an expanded polystyrene seedling container having a number of open ended cavities formed therein for receiving seeds or for planting purposes. Water and nutrition and the other medicines should be introduced into the cavities frequently and manually for allowing the plants to grow properly. It takes time and endeavor and effort, and it takes much labor work to have the plants grow well.

U.S. Pat. No. 5,020,275 to Bednarzik discloses the other typical planting devices and comprises a double pot arrangement having a complicated structure or configuration and having a number of elements for watering the plants. Water and nutrition and the other medicines should also be introduced into the double pot arrangement frequently for allowing the plants to grow properly. It also takes time and much endeavor and much effort and much labor work to have the plants grow well.

Typical aquatic animals breeding pools are exposed to the sun, such that the aquatic animals have no place to hide from the sun. In addition, a number of water wheels are required to be provided and disposed on the pools and are required to be pumped or actuated to pump the fresh air into the pools and to breathe the aquatic animals. Some times, a water cycling system or a filtering apparatus is further required to filter the water and to provide the aquatic animals a clean and comfortable living environment.

The present invention has arisen to mitigate and/or obviate the afore-described disadvantages of the conventional planting devices.

### SUMMARY OF THE INVENTION

The primary objective of the present invention is to provide a floatable planting apparatus for growing the plants naturally.

The other objective of the present invention is to provide a floatable planting apparatus for growing the plants without watering and without providing nutrition to the plants.

The further objective of the present invention is to provide a floatable planting apparatus for covering and shading the pools and for cleaning the water and for providing air to the pools and for providing an improved aquatic animals breeding environment.

In accordance with one aspect of the invention, there is provided a floatable planting device includes two or more floatable bases coupled together with a coupling means for floating or buoyant on the pool and for supporting and growing the plants naturally without watering and without providing nutrition to the plants. The bases may be used for shading the pools and for cleaning the water and for airing the pools and for improving the aquatic animals breeding environment to a comfortable environment.

The coupling means includes a first coupler coupled to the first floatable base, a second coupler coupled to the second floatable base, and means for connecting the first and the second couplers together to couple the first floatable base and the second floatable base together.

The first floatable base and the second floatable base each includes at least one aperture formed therein, the first and the second couplers each includes a leg engaged into the apertures of the first floatable base and the second floatable base.

The legs each includes a spring biased catch for engaging with the first floatable base and the second floatable base and for securing the first and the second couplers to the first floatable base and the second floatable base.

The first and the second couplers each includes at least one hinge portion formed by at least one groove of the like for forming a flexible structure to the first and the second couplers.

The first and the second couplers each includes a free end, the connecting means includes at least one tongue extended from the free end of each of the first and the second couplers and engaged with each other for connecting the first and the second couplers together.

The tongues of the first and the second couplers each includes a catch engaged with the second and the first couplers respectively for connecting the first and the second couplers together.

The first and the second couplers each includes a hole formed in the free end thereof, the tongues of the first and the second couplers and engaged through the holes of the first and the second couplers respectively for connecting the first and the second couplers together.

The coupling means may includes at least one bar or at least one link having two end engaged in the slots of the first floatable base and the second floatable base respectively and having two end fingers engaged into the apertures of the first floatable base and the second floatable base respectively.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a top plan view of a floatable planting apparatus in accordance with the present invention;

FIG. 2 is a cross sectional view taken along lines 2-2 of FIG. 1;

FIG. 3 is an exploded view of a coupling device for the floatable planting apparatus;

FIGS. 4 and 5 are enlarged partial cross sectional views illustrating the operation of the floatable planting apparatus;

FIG. 6 is a perspective view illustrating the operation of the floatable planting apparatus;

FIG. 7 is a top plan view similar to FIG. 1, illustrating the operation of the floatable planting apparatus;

FIG. 8 is a partial cross sectional view taken along lines 8-8 of FIG. 7;

FIG. 9 is a partial cross sectional view similar to FIG. 8, illustrating the operation of the floatable planting apparatus;

FIG. 10 is an enlarged partial cross sectional view similar to FIGS. 4, 5, illustrating the other embodiment of the floatable planting apparatus;

FIG. 11 is a partial cross sectional view similar to FIG. 2, illustrating the further embodiment of the floatable planting apparatus; and

FIG. 12 is a top plan schematic view illustrating an aquatic animals breeding pool having the floatable planting apparatus in accordance with the present invention.

### DETAILED DESCRIPTION OF THE PREFERRED EMBODIMENT

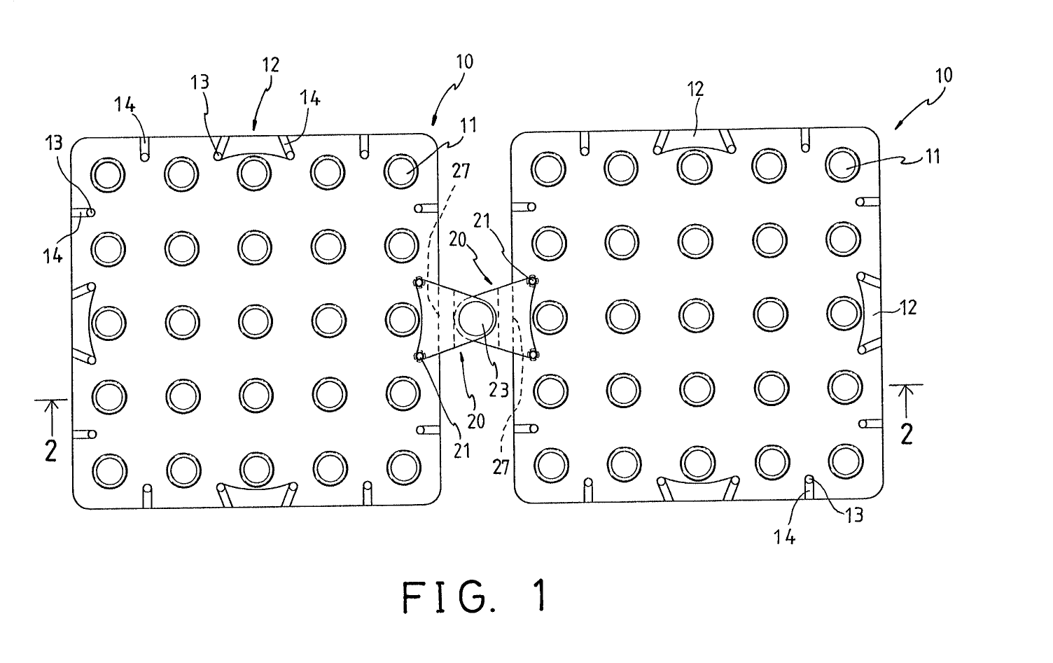

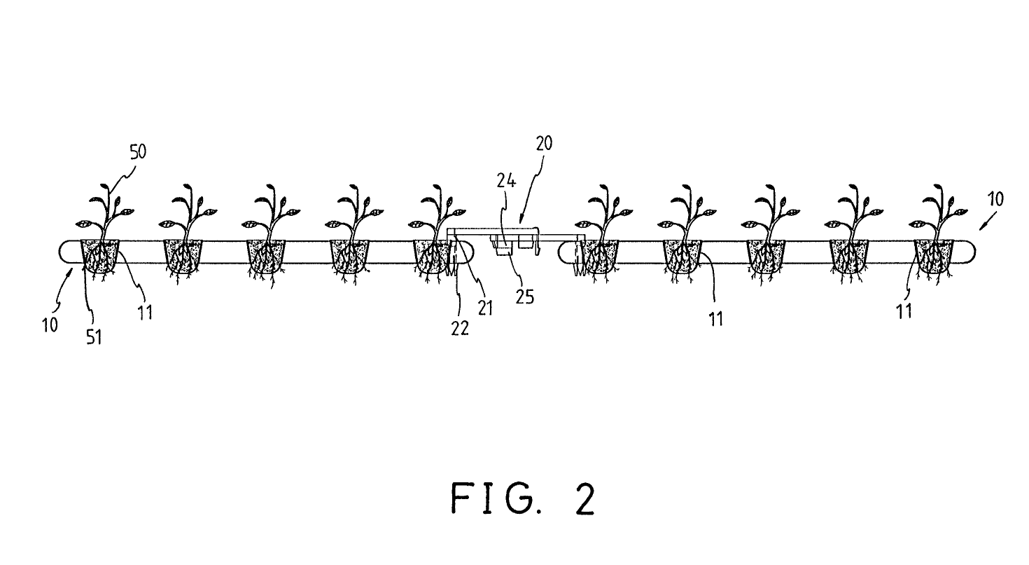

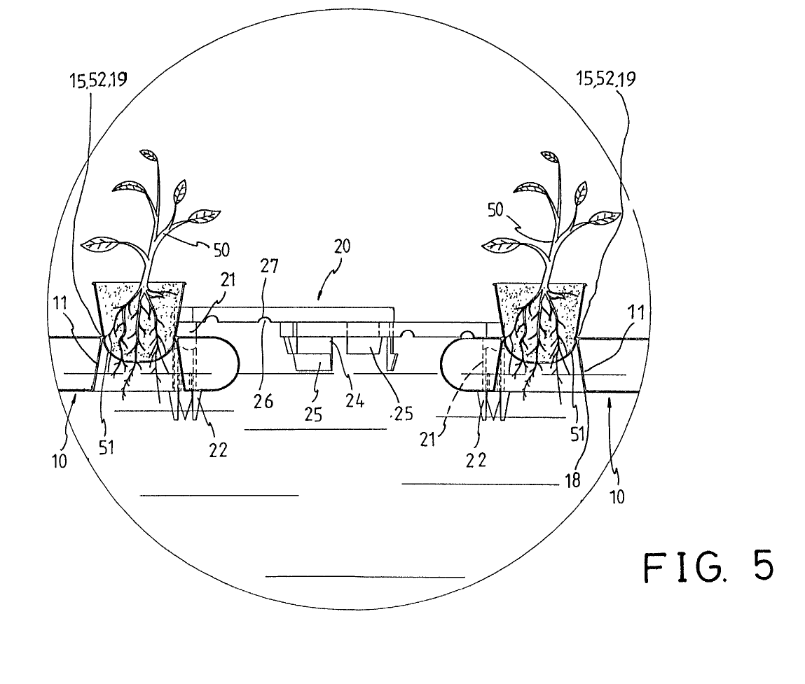

Referring to the drawings, and initially to FIGS. 1-5, a floatable planting apparatus in accordance with the present invention comprises two or more floatable bases 10 for supporting or for growing the plants, and one or more couplers 20 for coupling the floatable bases 10 together. The couplers 20 are preferably flexible for preventing the bases 10 from affecting each other. The bases 10 are made of floatable materials, such as the plastic materials, foamable materials, polystyrene materials, or the other light materials, for allowing the bases 10 to be floated and buoyant freely on water, best shown in FIG. 6.

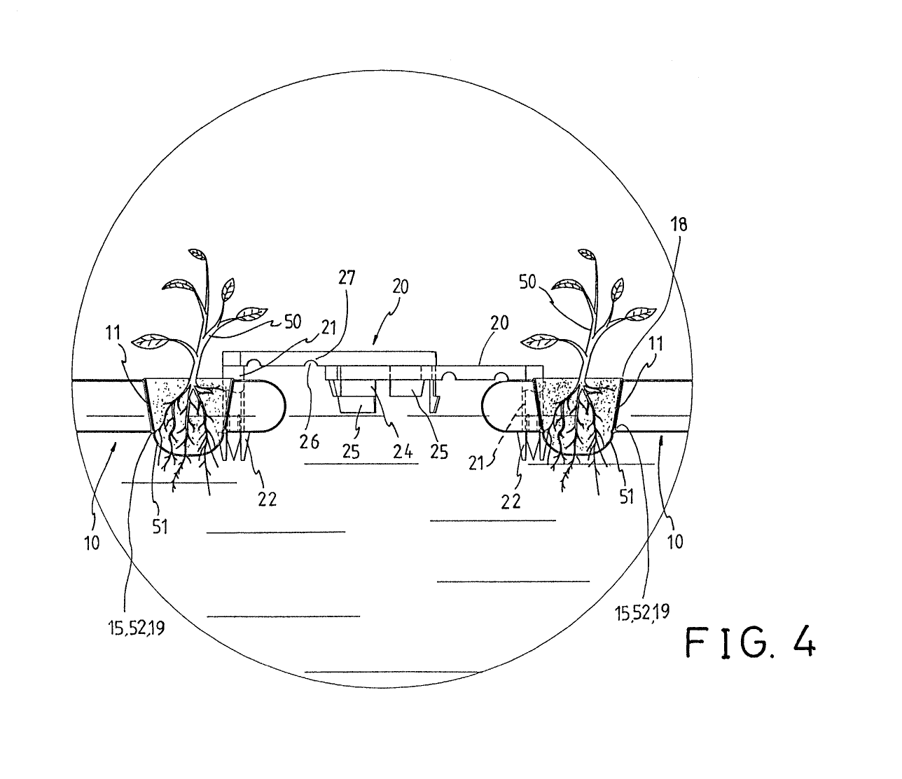

The floatable bases 10 each includes one or more open ended openings 11 formed therein and each formed or defined by an inclined or frustum-shaped inner peripheral surface, and each having one end 15 of a smaller inner diameter and the other end 18 of a greater inner diameter. The pots 51 for growing the plants 50 each includes an inclined or frustum-shaped inner peripheral surface corresponding to that of the openings 11 of the bases 10, for allowing the pots 51 to be stably received and supported in the openings 11 of the bases 10, best shown in FIG. 4. The bases 10 each includes a peripheral bead 19 extended inward from the smaller diameter end 15 of the respective opening 11, for engaging with the outer peripheral recess 52 of the pots 51, best shown in FIG. 5, and for supporting the pots 51 partially above the bases 10, when the bases 10 are disposed upside-down.

In operation, as shown in FIG. 4, the pots 51 may have the lower portion extended downward beyond the bases 10 and engaged in the water of the pool, and may include one or more slits or openings or holes formed in the lower portion thereof for allowing the roots of the plants to enter into the pool. The roots of the plants may clean the water of the pool and may some times provide air into the pool. As shown in FIG. 5, the pots 51 may also be supported at a higher position for preventing the lower portion of the pots 51 from being engaged into the water of the pool. The bases 10 may further be used for covering and shading the pools and for providing a comfortable aquatic animals breeding environment.

As shown in FIG. 1, the bases 10 each includes one or more apertures 13 and slots 14 formed in the outer peripheral portion thereof and communicating with each other, and each includes one or more depressions 12 formed in the outer peripheral portion thereof. The depressions 12 of the bases 10 may be formed between and communicated with two pairs of adjacent apertures 13 and slots 14 of the bases 10.

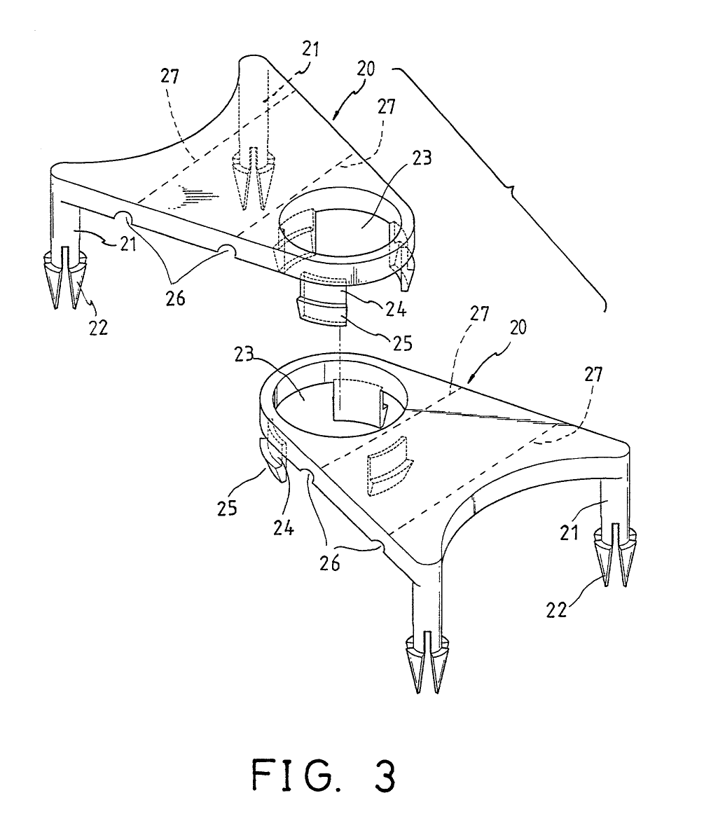

As best shown in FIGS. 3-5, the couplers 20 each includes one end engaged in the depressions 12 of the bases 10 and having one or more legs 21 extended therefrom for engaging into the apertures 13 of the bases 10. The legs 21 each includes a spring-biased catch 22 provided on the bottom portion thereof for engaging with the bases 10 and for locking the couplers 20 to the bases 10. The couplers 20 each includes a hole 23 formed in the other end or in the free end thereof, and one or more tongues 24 extended downward therefrom and arranged around the hole 23 thereof for engaging into the hole 23 of the other couplers 20 when the free ends of the couplers 20 are superposed with each other. The tongues 24 each includes a catch 25 for engaging with the other couplers 20 and for detachably securing the couplers 20 and thus the bases 10 together.

As best shown in FIGS. 4 and 5, the tongues 24 of the couplers 20 are not solidly engaged with each other, and have gaps formed or provided between the tongues 24, such that the couplers 20 and thus the bases 10 may be slightly rotated relative to each other. The couplers 20 each further includes one or more grooves 26 laterally formed therein, such as formed in the bottom portion thereof, for forming or defining one or more hinge portions 27 therein and for allowing the couplers 20 to be slightly bent and allowing the bases 10 to be flexibly coupled together with the couplers 20, and for allowing the bases 10 to be slightly moved upward and downward relative to each other. As shown in FIG. 6, a number of floatable bases 10 may thus be flexibly coupled together and may slightly rotate relative to each other and may slightly move upward and downward relative to each other. As also shown in FIG. 6, the couplers 20 may each include a single leg 21 engaged into the bases 10 for further rotatably coupling the couplers 20 and the bases 10 together.

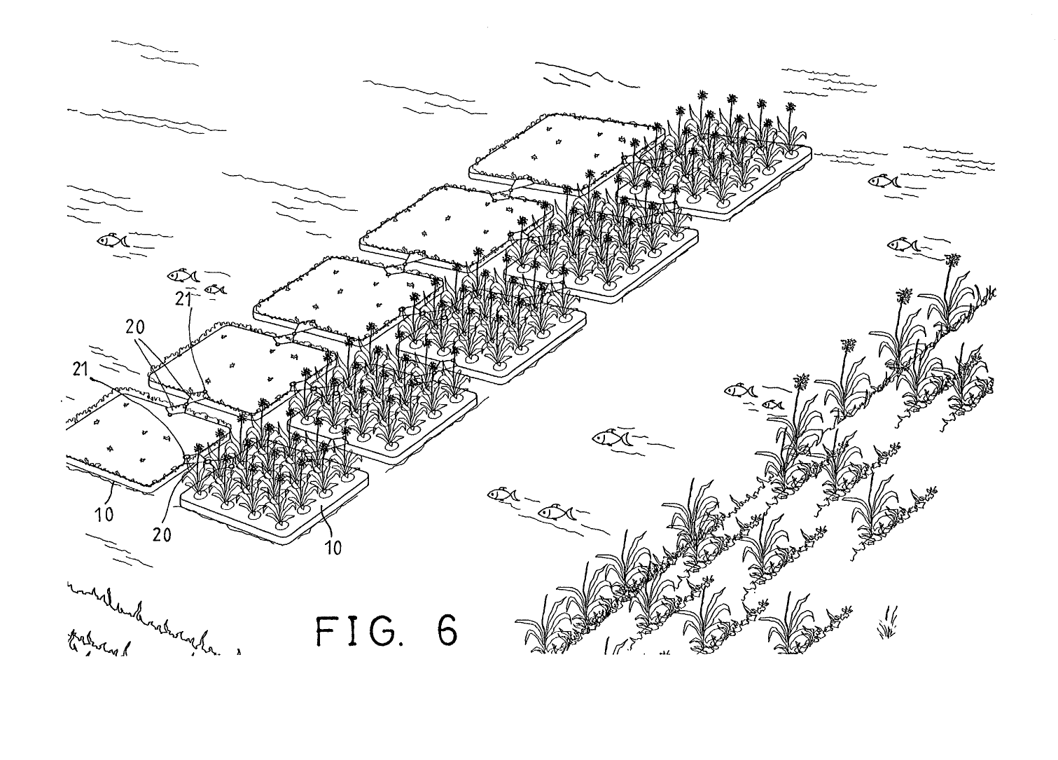

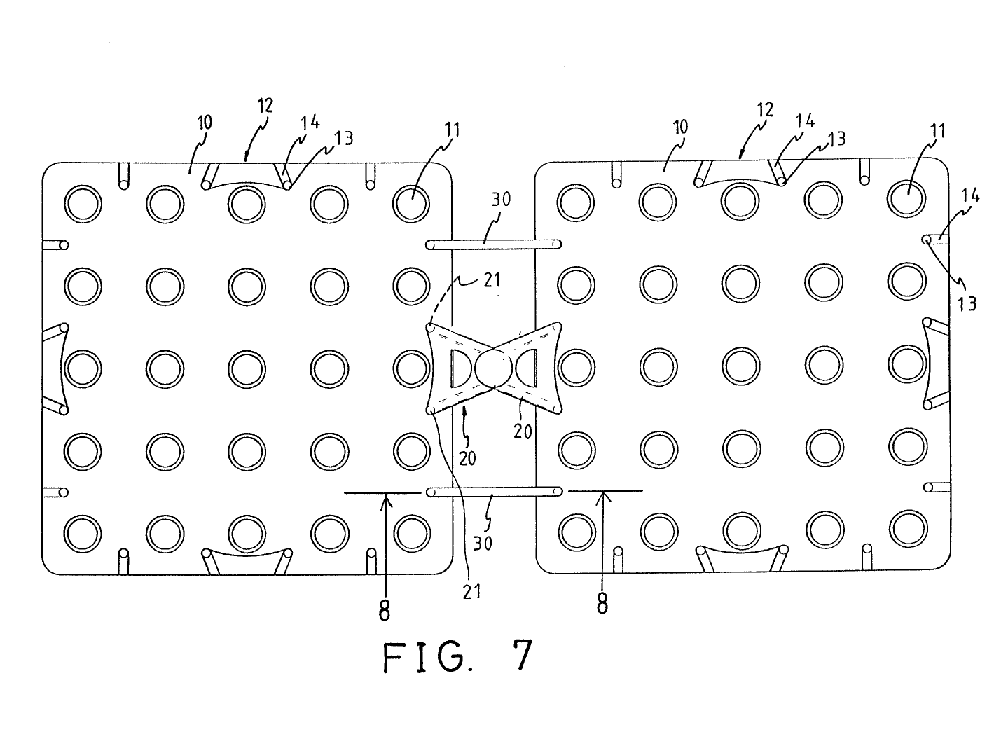

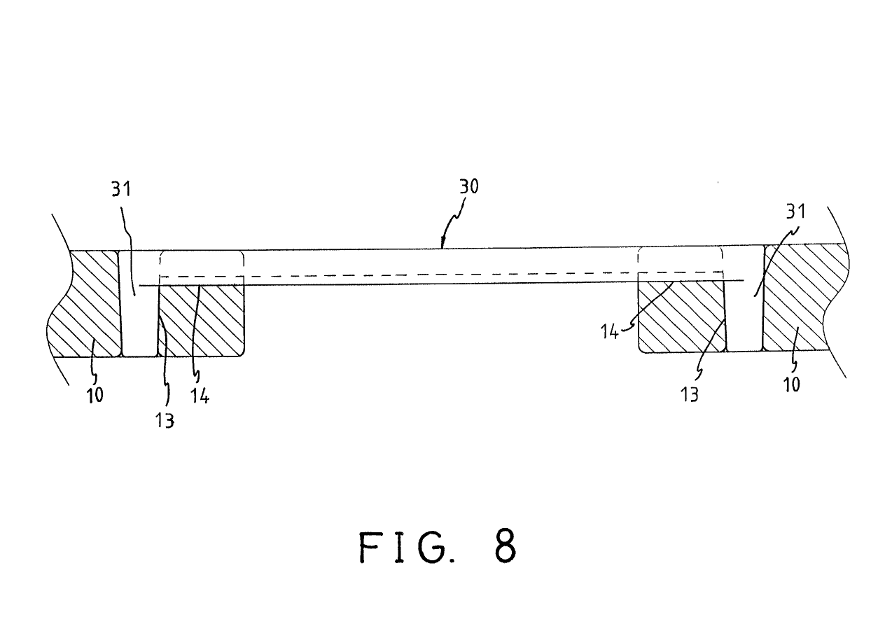

Referring next to FIGS. 7 and 8, the floatable planting apparatus further includes one or more bars 30 each having the ends engaged into the slots 14 of the bases 10, and each having a finger 31 extended from the end thereof for engaging into the apertures 13 of the bases 10 and for solidly coupling the bases 10 together and for preventing the bases 10 from rotating and moving relative to each other. As shown in FIG. 9, one or more links 33 are further provided and each includes the ends engaged into the slots 14 of the bases 10, and each includes a finger 34 extended from the end thereof for engaging into the apertures 13 of the bases 10 and for solidly coupling the bases 10 together and for preventing the bases 10 from rotating and moving relative to each other, when the couplers 20 are disengaged from the bases 10.

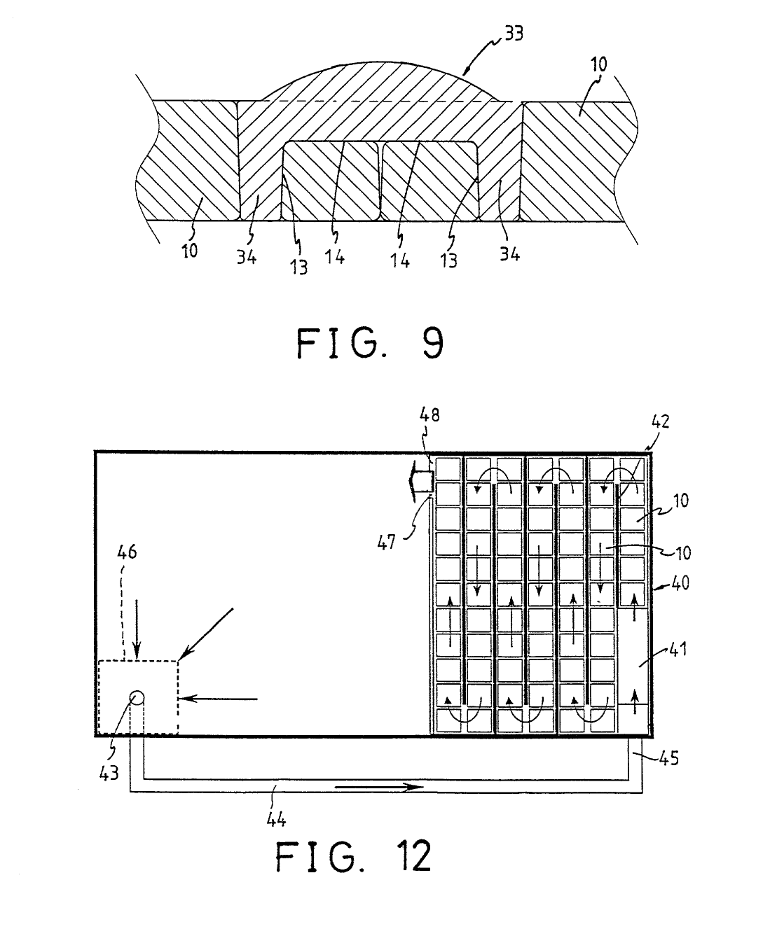

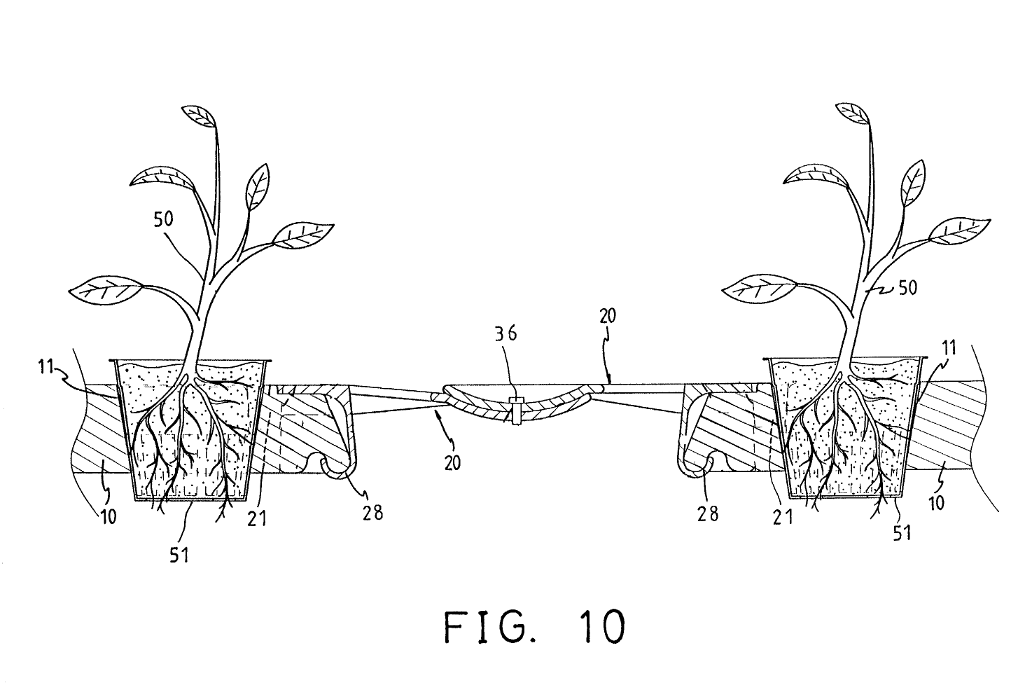

Referring next to FIG. 10, alternatively, the couplers 20 may each include a hook 28 provided on one end thereof for hooking to the bases 10, in addition to the legs 21 thereof. A pin 36 may rotatably couple the other ends of the couplers 20 together, for allowing the couplers 20 to be freely rotated relative to each other. Referring next to FIG. 11, the bases 10 may also each include one or more ears 16 extended outward therefrom and rotatably coupled together with a pin 17, such that the bases 10 may also be rotatably coupled together.

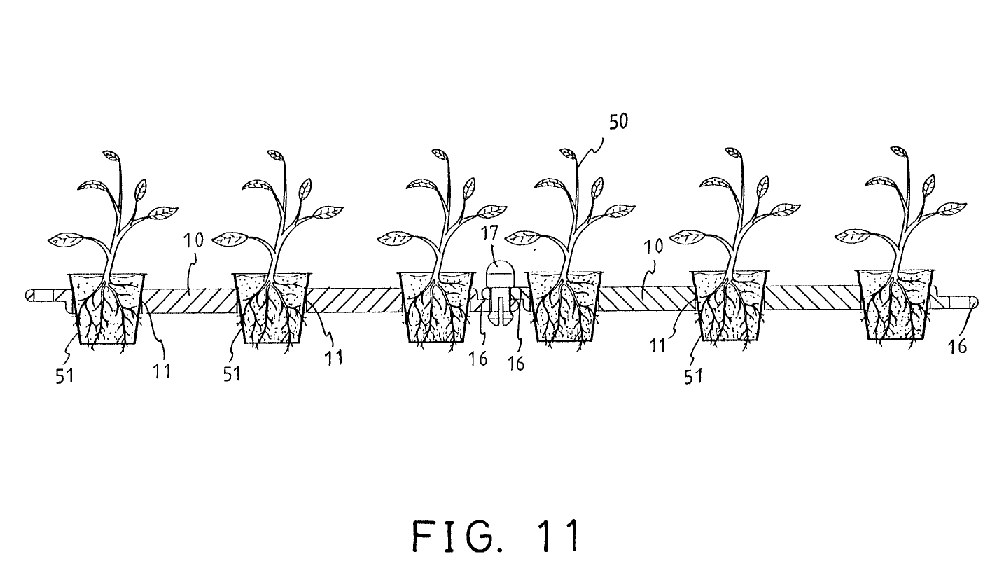

Referring next to FIG. 12, a pool 40 or the like may be used for receiving water and for breeding aquatic animals, and includes a water flowing passage 41 formed or provided therein and formed or defined by a number of partitions 42. The bases 10 may be arranged or disposed in the passage 41 of the pool 40. The pool 40 includes an outlet 43 coupled to a tube 44 which has one end 45 coupled to the passage 41 of the pool 40 for supplying the water to the passage 41 of the pool 40 and for planting the plants supported in the bases 10 which may filter or clean the water flowing through the passage 41 of the pool 40. A filter screen 46 is provided around the outlet 43 for preventing the aquatic animals from entering into the outlet 43 of the pool 40. The passage 41 of the pool 40 includes an exit 47 having a filter screen 48 disposed therein for filtering purposes.

It is to be noted that the plants supported in the pots 51 or directly received in the openings 11 of the bases 10 may grow with the water of the pool without watering the plants and without providing nutrition to the plants. In addition, the plants may also clean the water and may provide air into the water of the pool and provide a shade or cover to the aquatic animals. The discharges of the aquatic animals may also feed or provide the nutrition to the plants.

Accordingly, the floatable planting apparatus in accordance with the present invention may be used for growing the plants naturally, and without watering and without providing nutrition to the plants, and may be used for covering and shading the pools and for cleaning the water and for providing air to the pools and for providing an improved aquatic animals breeding environment.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A floatable planting apparatus comprising:
a first floatable base,
at least one second floatable base, and
means for flexibly coupling said first floatable base and said at least one second floatable base together.

2. A floatable planting apparatus comprising:
a first floatable base,
at least one second floatable base, and
means for rotatably coupling said first floatable base and said at least one second floatable base together.

3. A floatable planting apparatus comprising:
a first floatable base,
at least one second floatable base, and
means for coupling said first floatable base and said at least one second floatable base together.

4. The floatable planting apparatus according to claim 3, wherein said coupling means includes a first coupler coupled to said first floatable base, a second coupler coupled to said at least one second floatable base, and means for connecting said first and said second couplers together to couple said first floatable base and said at least one second floatable base together.

5. The floatable planting apparatus according to claim 4, wherein said first floatable base and said at least one second floatable base each includes at least one aperture formed therein, said first and said second couplers each includes a leg engaged into said at least one apertures of said first floatable base and said at least one second floatable base.

6. The floatable planting apparatus according to claim 5, wherein said legs each includes a spring biased catch for engaging with said first floatable base and said at least one second floatable base and for securing said first and said second couplers to said first floatable base and said at least one second floatable base.

7. The floatable planting apparatus according to claim 4, wherein said first and said second couplers each includes at least one hinge portion formed therein for forming a flexible structure to said first and said second couplers.

8. The floatable planting apparatus according to claim 7, wherein said first and said second couplers each includes at least one groove formed therein for forming said hinge portion thereof and for forming the flexible structure to said first and said second couplers.

9. The floatable planting apparatus according to claim 4, wherein said first and said second couplers each includes a free end, said connecting means includes at least one tongue extended from said free end of each of said first and said second couplers and engaged with each other for connecting said first and said second couplers together.

10. The floatable planting apparatus according to claim 9, wherein said at least one tongues of said first and said second couplers each includes a catch engaged with said second and said first couplers respectively for connecting said first and said second couplers together.

11. The floatable planting apparatus according to claim 9, wherein said first and said second couplers each includes a hole formed in said free end thereof, said at least one tongues of said first and said second couplers and engaged through said holes of said first and said second couplers respectively for connecting said first and said second couplers together.

12. The floatable planting apparatus according to claim 3, wherein said first floatable base and said at least one second floatable base each includes at least one aperture formed therein, said coupling means includes at least one bar having two ends engaged into said at least one apertures of said first floatable base and said at least one second floatable base.

13. The floatable planting apparatus according to claim 12, wherein said two ends of said at least one bar each includes a finger extended therefrom and engaged into said at least one apertures of said first floatable base and said at least one second floatable base respectively.

14. The floatable planting apparatus according to claim 13, wherein said first floatable base and said at least one second floatable base each includes a slot formed therein and communicating with said at least one aperture thereof for receiving said ends of said at least one bar respectively.

15. The floatable planting apparatus according to claim 3, wherein said first floatable base and said at least one second floatable base each includes a slot and at least one aperture formed therein and communicating with each other, said coupling means includes at least one link having two end engaged in said slots of said first floatable base and said at least one second floatable base respectively and having two end fingers engaged into said at least one apertures of said first floatable base and said at least one second floatable base respectively.
